(19) United States
(12) Patent Application Publication
(10) Pub. No.: US 2018/0239359 A1
(43) Pub. Date: Aug. 23, 2018

(54) SYSTEM AND METHOD FOR DETERMINING NAVIGATIONAL HAZARDS

(71) Applicant: Faraday&Future Inc., Gardena, CA (US)

(72) Inventor: Yong-Dian Jian, Campbell, CA (US)

(21) Appl. No.: 15/679,033

(22) Filed: Aug. 16, 2017

Related U.S. Application Data
(60) Provisional application No. 62/375,818, filed on Aug. 16, 2016.

(51) Int. Cl. G05D 1/02; G05D 1/00; G01C 21/34

(52) U.S. Cl. CPC G05D 1/0214; G05D 1/0223; G05D 1/0061; G05D 2201/0213; G05D 1/0278; G05D 1/028; G01C 21/3461; G05D 1/0274

(57) ABSTRACT

A system and method for identifying navigational hazards is disclosed. In some examples, the system can be included in, or the method can be performed by, a vehicle. One or more sensors included in the vehicle can gather perception data related to potentially dangerous driving conditions, such as blind corners, reckless drivers, accidents, and other hazards. The data can be associated with the location at which it was collected to predict future hazardous conditions at the same location. In some examples, a navigational system can use the data to determine the relative safety of one or more routes for driving to a destination. In some examples, a fully or partially autonomous vehicle can modify its driving behavior based on the relative safety of its location. Modifying driving behavior can include, for example, changing a top speed, a following distance, and conditions for changing lanes. In some examples, data from a plurality of vehicles can be uploaded to a remote server configured to model location-based danger. The model can be downloaded by one or more vehicles.

### CROSS-REFERENCE TO RELATED APPLICATIONS

This application claims the benefit of U.S. Provisional Application No. 62/375,818, filed Aug. 16, 2016, the entirety of which is hereby incorporated by reference.

### FIELD OF THE DISCLOSURE

The present disclosure generally relates to vehicle navigation, and more specifically to providing a route for a vehicle that takes into account current driving conditions, previously observed driving conditions, and user preferences.

### BACKGROUND OF THE DISCLOSURE

Many modern vehicles, especially automobiles, are capable of planning or suggesting possible routes for a vehicle to travel from the vehicle's current location to a user specified destination. Some vehicles, for example, can include a navigation system in communication with one or more location sensors (e.g., GPS) to track the vehicle's location and provide directions to navigate from a first point to a second point. In some examples, navigation systems can inform a driver which turns to make to follow the route. An autonomous vehicle, however, can follow a route provided by its navigation system with less need for human intervention.

### SUMMARY OF THE DISCLOSURE

The following presents a simplified summary of one or more examples in order to provide a basic understanding of the disclosure. This summary is not an extensive overview of all contemplated examples, and is not intended to either identify key or critical elements of all examples or delineate the scope of any or all examples. Its purpose is to present some concepts of one or more examples in a simplified form as a prelude to the more detailed description that is presented below.

The present disclosure describes a system and method for vehicles (e.g., automobiles) that detect and gather persistent information about the safety or danger of driving conditions at various locations over a specified period of time. Some vehicles, such as automobiles, may include various modules (e.g., sensors, controllers, etc.) to enable the vehicle to drive autonomously. Some vehicles may drive autonomously according to an algorithm that considers a current vehicle pose and current obstacles surrounding the vehicle. In some examples, vehicle pose may include a location of a vehicle at the current time, and may include an orientation of the vehicle (e.g., a cardinal orientation based on direction of travel). However, current vehicle pose and current obstacles alone may not provide all information relevant to autonomous operation of a vehicle. Examples of the disclosure are directed to determining danger values associated with several locations based on various considerations, such as the number of dangerous incidents observed near each location for a specified period of time, and characteristics about the environment near each location, among other considerations. In this way, the vehicle can operate autonomously based on current and previously observed driving conditions, and can consider both user safety and vehicle efficiency during autonomous operation.

### BRIEF DESCRIPTION OF THE DRAWINGS

FIG. 1 illustrates an exemplary process for autonomous driving according to examples of the disclosure.

FIG. 2A illustrates an exemplary danger map according to examples of the disclosure.

FIG. 2B illustrates an exemplary process for operating a vehicle according to examples of the disclosure.

FIG. 3 illustrates an exemplary process for collecting perception data and determining a danger value according to examples of the disclosure.

FIG. 4 illustrates an exemplary system block diagram of a vehicle control system according to examples of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Many modern vehicles, especially automobiles, are capable of planning or suggesting possible routes for a vehicle to travel from the vehicle's current location to a user specified destination. Some vehicles, for example, can include a navigation system in communication with one or more location sensors (e.g., GPS) to track the vehicle's location and provide directions to navigate from a first point to a second point. In some examples, navigation systems can inform a driver which turns to make to follow the route. An autonomous vehicle, however, can follow a route provided by its navigation system with less need for human intervention.

The present disclosure describes a system and method for vehicles (e.g., automobiles) that detect and gather persistent information about the safety or danger of driving conditions at various locations over a specified period of time. Some vehicles, such as automobiles, may include various modules (e.g., sensors, controllers, etc.) to enable the vehicle to drive autonomously. Some vehicles may drive autonomously according to an algorithm that considers a current vehicle pose and current obstacles surrounding the vehicle. In some examples, vehicle pose may include a location of a vehicle at the current time, and may include an orientation of the vehicle (e.g., a cardinal orientation based on direction of travel). However, current vehicle pose and current obstacles alone may not provide all information relevant to autonomous operation of a vehicle. Examples of the disclosure are directed to determining danger values associated with several locations based on various considerations, such as the number of dangerous incidents observed near each location for a specified period of time, and characteristics about the environment near each location, among other considerations. In this way, the vehicle can operate autonomously based on current and previously observed driving conditions, and can consider both user safety and vehicle efficiency during autonomous operation.

Various apparatuses and methods will be described in the following detailed description and illustrated in the accompanying drawing by various blocks, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

The present disclosure describes a system and method for vehicles (e.g., automobiles) that detects and gathers persistent information about the safety or danger of driving conditions at various locations over a specified period of time. Some vehicles, such as automobiles, may include various modules to enable the vehicle to drive autonomously. Some vehicles may drive autonomously according to an algorithm than considers a current vehicle pose and current obstacles surrounding the vehicle. In some examples, a current vehicle pose may include a location of a vehicle at the current time, and may include an orientation of the vehicle (e.g., a cardinal orientation based on direction of travel). However, current vehicle pose and current obstacles alone may not provide all information relevant to autonomous operation of a vehicle. Examples of the disclosure are directed to determining danger values associated with several locations based on various considerations, such as the number of dangerous incidents observed near each location for a specified period of time, and characteristics about the environment near each location, among other considerations. In this way, the vehicle can operate autonomously based on current and previously observed driving conditions, and can consider both user safety and vehicle efficiency during autonomous operation.

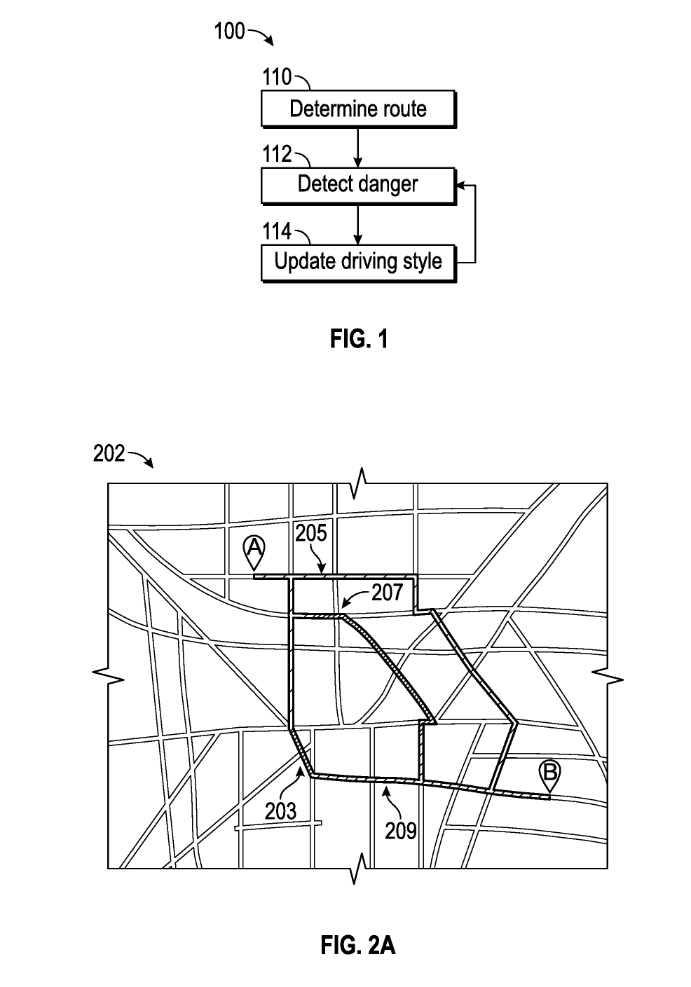

FIG. 1 illustrates an exemplary process 100 for autonomous driving according to examples of the disclosure. In some examples, process 100 can detect one or more dangerous conditions of a vehicle's surroundings based on information from various sensors. In response, the operation of the vehicle can be modified, for example. Process 100 can be performed continuously or repeatedly by the vehicle whenever information about the safety of vehicle's current operation is needed.

At 110, a vehicle may determine a route to travel from a current location of the vehicle to a destination indicated (e.g., via a user interface of a navigation system, a button or switch, voice command, etc.) by a user. The vehicle may determine a route based on input from a GPS receiver and/or using a GPS navigation map. In some examples, the vehicle may identify several possible routes to arrive at the indicated destination, and may compare one or more routes according to various criteria. For example, the vehicle may identify two possible routes to arrive at the indicated destination, and may choose a route based on the amount of time predicted for each route. The vehicle may present any identified routes on a vehicle display to allow a user to change one or more criteria (e.g., time, distance, energy efficiency, etc.) for selecting a route or to allow a user to manually select between various possible routes. In some examples, the vehicle may display to the user only a few suggested routes of several possible routes identified by the vehicle.

At 112, the vehicle may detect one or more dangerous characteristics of the vehicle's current surroundings. In some examples, dangerous characteristics may include a vehicle collision, a near miss, an extreme velocity of another vehicle, excessive acceleration of another vehicle, motorcycles, pedestrians, parking lots, a sharp turn, a blind corner, construction, or debris, among other characteristics of a vehicle's surroundings. The vehicle may be equipped with various sensors to detect its current surroundings, such as cameras, radar, ultrasonic, LiDAR, etc. In some examples, the vehicle may collect perception data indicative of the vehicle's current surroundings and may analyze the perception data for any indication of danger or of a dangerous characteristic of the vehicle's surroundings.

At 114, the vehicle may modify its operation in response to the one or more dangerous characteristics detected by the vehicle at 112. In some examples, these modifications can be performed by an onboard computer of the vehicle. In some examples, modifying the vehicle's operation can include performing a maneuver (e.g., applying the brakes, decelerating, turning, etc.) to avoid a collision. In some examples, modifying the vehicle's operation may include updating a driving style of the vehicle. A driving style may include factors indicating how conservatively the vehicle will drive. These factors can include a minimum distance between the vehicle and other objects (e.g., other vehicles), under what conditions the vehicle will change lanes, a maximum velocity of the vehicle, a maximum acceleration of the vehicle, ideal breaking distance, and operation of the vehicle overall, among other factors. The factors of a driving style can be controlled by the vehicle, by the user, or by any combination thereof. Additionally or alternatively, in some examples, a vehicle can modify its route based on the danger it perceives.

According to the examples described with reference to FIG. 1 an autonomous vehicle can select a route based on user-selected criteria and to autonomously drive along the route adjusting its behavior for perceived danger. Although these examples provide for user convenience and safety, the above-described examples may not provide a way to avoid danger altogether. Therefore, it can be advantageous to store location-based perception data indicative of dangerous situations so that an autonomous vehicle can predict which areas along one or more routes will be dangerous and adjust its driving behavior and selected route accordingly.

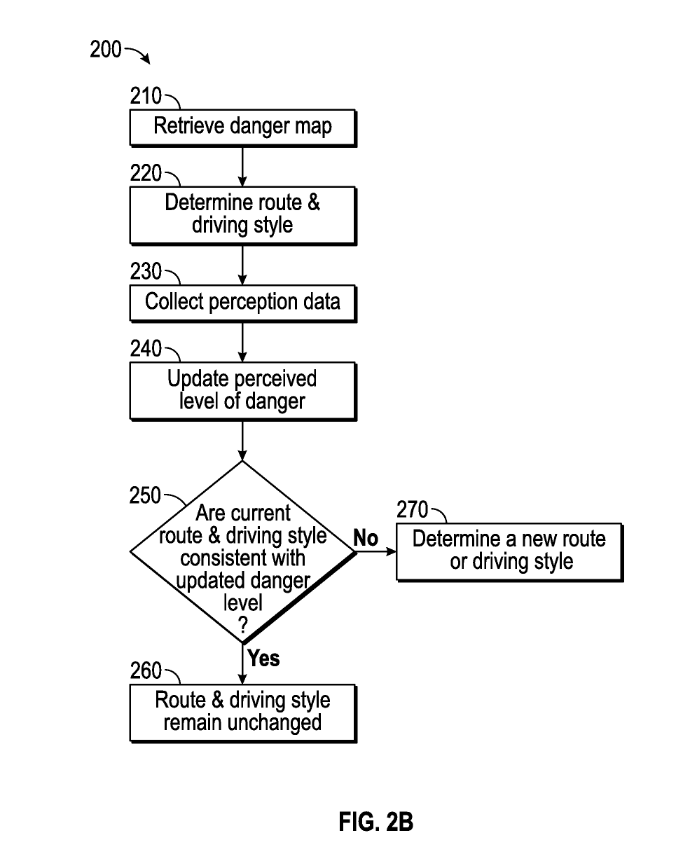

FIG. 2A illustrates an exemplary danger map 202 according to examples of the disclosure. In some examples, danger map 202 can include danger values, each danger value corresponding to a level of driving risk at one or more particular locations included in the danger map, as will be described below. The danger map 202 can include one or more features and/or capabilities of a high definition (HD) navigation map. For example, the danger map 202 can include information associated with terrain, buildings, street markings and signs, and enable basic navigation from a first location (e.g., A or location A) to a second location (e.g., B or location B). In some examples, an HD navigation map may be a map of a vehicle's environment with sufficient detail to enable at least partially autonomous operation of the vehicle. In particular, an example of an HD navigation map can include a description of known pathways (e.g., roads) that a vehicle may take to travel from one location to arrive at another location. In some examples, an HD map can include one or more landmarks or features that the vehicle can detect and track to resolve its location with greater accuracy than possible with consumer-grade GPS. A fully or partially autonomous vehicle can detect these features to verify its location, for example.

In some examples, an occupant of the vehicle can specify location A as a starting location and can specify location B as a destination. In some examples, a vehicle's starting point can automatically be obtained based on data from one or more location sensors, such as GPS, or based on data from an HD map. In response, the vehicle can retrieve and display the danger map 202 that includes various routes from location A to location B, and displays a danger level associated with each location along the routes.

For example, the danger map 202 illustrates a high danger value associated with location 203 (indicated, e.g., with heavy shading), a low danger value associated with location 205 (indicated, e.g., with light shading), a high danger value associated with location 207, and a middling danger value associated with location 209. As displayed in danger map 202, in some examples, a danger map may display a danger value as a shading of a location of an HD navigation map (e.g., black and white shading, color shading, etc.). Alternatively or in addition, a danger map can display a danger value as a popup window in response to a user selecting to view a danger value associated with a location. As described in greater detail below, a danger value of the danger map 202 can be based on perception data that is collected over a period of time, and that may indicate that a dangerous incident or circumstance was detected by a vehicle. In some examples, a danger map may display a danger value at every location of the map. More specifically, some examples of a danger map can be colored and/or shaded at every location displayed by the map, where the color and/or shading can indicate a danger value, as described above. In some examples, the perception data can be collected by a same vehicle using the danger map. In some examples, the perception data can be collected by one or more other vehicles instead of or in addition to the danger data collected by the same vehicle. Perception data can be shared among vehicles via direct wireless network connections or through a remote server in wireless communication with the vehicles.

A danger map may indicate the extent of probable danger associated with several locations of an HD navigation map. In particular, a danger map can include an HD navigation map designating several locations with a danger value associated with one or more locations designated by the HD navigation map. A danger value of a danger map can be associated with a location on the danger map, and may be based on, or indicate, any dangerous incidents or circumstances associated with that location. For example, a large danger value at a location of a danger map may indicate a large number of dangerous incidents or circumstances (collisions, near-misses, etc.) have previously been detected near that location (e.g., over the last year, the last month, the last week, etc.). As another example, a danger value may be based on an attribute associated with crime in a particular area, or an area indicated by input (e.g., input by a user, which may indicate one or more streets/routes that a user may not want to travel through for one reason or another, such as a route that passes through a “bad neighborhood”). Thus, a danger map, or a portion thereof, may include a display of several danger values at associated locations of an HD navigation map.

In some examples, a danger map's danger values may be based on perception data (e.g., data indicating whether any dangerous condition was detected at the associated location), as described in greater detail with reference to FIG. 2B below. The vehicle may utilize the danger map (e.g., the various danger values of the map) in evaluating, displaying, or selecting a route of the vehicle. Some examples may use a danger map to determine that one or more locations of a particular route are associated with sufficiently large danger values, such that the route that includes those locations is not displayed to a user.

In some examples, a vehicle may utilize a danger map to select a route, out of several possible routes, by determining that the selected route includes a lowest aggregate danger value associated with its various locations compared to the aggregate danger values of the other possible routes. In some examples, the aggregate danger values can be an average of all danger values along the route, a maximum danger value along the route, or another function of the danger values along the route. Accordingly, based on a danger layout (e.g., locations and levels of various danger values) of the danger map, the vehicle can select a route to use, for example. In some examples, the vehicle may utilize a danger map to select a route, of several possible routes, based on an evaluation of relevant tradeoffs between each of the possible routes. For example, a vehicle may select a route based on a tradeoff or simultaneous comparison of various considerations of each route (e.g., average danger value, duration, distance). In some examples, the outcome of a tradeoff determined by the vehicle, or the weight of one consideration relative to another consideration, may depend on one or more preferences of the vehicle's passengers. For example, a vehicle's passengers may include a baby, and the vehicle may weigh the average danger value of each route more heavily than the duration, distance, or some other tradeoff of each route. If, however, all vehicle occupants are adults, the vehicle may weigh the average danger value of each route less heavily than duration, distance, or some other tradeoff, for example.

FIG. 2B illustrates an exemplary process 200 for operating a vehicle according to examples of the disclosure. Process 200 may include operating a vehicle based on a danger map, (e.g., the danger map described with reference to FIG. 2A) according to examples of the disclosure. Process 200 can be performed continuously or repeatedly by the vehicle. Process 200 may be performed by the vehicle whenever information about a danger value of vehicle's current operation is received or requested. Alternatively or in addition, process 200 may be performed whenever the vehicle collects or receives perception data associated with a location of a danger map. The process 200 can be performed by an autonomous vehicle or non-autonomous vehicles.

At block 210, in some examples, the vehicle may retrieve a danger map from a computer readable storage media or may download the danger map (e.g., danger map 202 described with reference to FIG. 2A) from a remote database using a wireless communications module.

At block 220, in some examples, the vehicle may determine a route and a driving style. To determine a route, the vehicle may identify one or more possible routes for the vehicle to travel to a specified destination. A route of a vehicle may be associated with an aggregate danger value specific to that route. In some examples, an aggregate danger value associated with a route may be an average of the danger values associated with all locations defined along the route. For example, a route for a vehicle to travel from location A to location B, with intermediate locations A1, A2, and A3 between A and B, may equal the average danger value of intermediate locations A, A1, A2, A3, and B. In some examples, a route of a vehicle may be associated with a maximum danger value of any danger value associated with an intermediate location defined along the route. Further, in other examples, a danger value associated with a route may be a most common danger value of the danger values associated with the intermediate locations along the route.

The vehicle may suggest one or more routes to the user on a vehicle display. The routes may be displayed in an order specified by relevant criteria or user preferences, such as the safety, energy efficiency, distance, or duration of each route. For example, a user may specify a maximum danger value for any location included in a suggested route, and in response the vehicle may display routes without any location associated with a danger value exceeding the specified maximum danger value. Alternatively or in addition, a user may specify a preference for energy efficiency (or any other criterion) over minimal danger value of a suggested route.

A vehicle may determine a driving style based on a danger value of a route selected by the user and based on one or more user preferences. In some examples, the vehicle selects the route itself, rather than presenting the user with multiple optional routes. A driving style may also be referred to as a driving mode, a vehicle mode, a driving configuration, or a mode of operation. As described with reference to FIG. 1, a driving style may include factors indicating how conservatively the vehicle will drive (e.g., minimum following distance, conditions for changing lanes, breaking distance, and the like). The factors of a driving style can be controlled by the vehicle, by the user, or by any combination thereof. In some examples, the vehicle can select (or determine) a driving style for various locations along a route of the vehicle. For example, the vehicle may select a more cautious driving style for relatively dangerous locations of the route, and may select a less cautious driving style for relatively safe locations of the route.

Additionally or alternatively, in some examples, a vehicle can change its driving mode (e.g., a degree of autonomy) based on a danger value of its current or future location. For example, in accordance with a determination that danger is below an autonomous driving threshold, the vehicle can operate in a fully autonomous mode. In accordance with a determination that danger is above a manual driving threshold, the vehicle can operate in a fully manual mode, for example. In some examples, a vehicle can operate with two or more driving mode thresholds to determine when to enter one of three or more driving modes such as a fully autonomous mode, a partially autonomous mode, and a fully manual mode.

A vehicle may select (or determine) a driving style for a location of its route at any suitable time. For example, the vehicle may select driving styles for the various locations of a route after the route is determined and before the vehicle begins traveling along the route. As another example, the vehicle may first select driving styles of the various locations as the vehicle travels along the route (e.g., selecting driving styles in real-time as the vehicle reaches each location along the route). As still another example, the vehicle may select the various driving styles before traveling along the route, and may alter, or replace, a previously selected driving style with a new driving style (e.g., in response to detecting unexpected danger).

At block 230, in some examples, the vehicle may collect or receive perception data with information about the vehicle's surroundings (e.g., nearby objects, traffic conditions, road conditions, etc.). In some examples, the perception data can indicate a dangerous incident or circumstance. A dangerous incident or circumstance may include incidents and circumstances such as a vehicle collision, a near-miss, excessive vehicle acceleration, a motorcycle, a sharp turn, a blind corner, a school, a parking lot, and an area with many pedestrians, among others. The vehicle can collect perception data indicating an absence of any dangerous incident or circumstance, or indicating a failure to detect any dangerous incident or circumstance. In some examples, the vehicle may communicate and receive perception data without regard to whether it indicates a dangerous incident or circumstance is present or absent at a location. In some examples, a plurality of vehicles can be in communication (e.g., via a wireless network) to allow a danger value of a location to be based on the associated perception data of the plurality of vehicles in a collective fashion.

The vehicle may collect perception data indicating a dangerous incident or circumstance directly, such as from outputs of the vehicle's various sensors detecting a dangerous aspect of the vehicle's surroundings. The vehicle may also receive perception data indicating a dangerous incident or circumstance indirectly, such as by receiving notification (e.g., wirelessly from another vehicle, a remote server, a smart traffic signal, or other device) of an accident at a location ahead of the vehicle and along a planned route of the vehicle. Alternatively or in addition, the vehicle may communicate sensor data or perception data to a server that determines whether the data indicates a dangerous incident or circumstance has been detected. In some examples, collecting perception data, receiving perception data, and/or communicating perception data (or any combination thereof) can occur in real-time or via a remote server (e.g., uploading collected data to a remoter server) at a later time. For example, the vehicle may upload collected perception data to a server during vehicle startup, during scheduled updates of the vehicle, in response to an unscheduled request for collected perception data, and the like. As described herein, perception data can include data collected by the various sensors (e.g., as radar, ultrasonic, LiDAR, etc.) of a vehicle. Thus, perception data may include data collected by one vehicle and communicated to another vehicle, and may further refer to similar data collected by stoplights, intersection sensors, traffic equipment, and the like (e.g., traffic data). Alternatively or in addition, a plurality of vehicles in communication may share one or more danger maps between each other or may share one or more portions thereof.

At block 240, in some examples, a perceived level of danger can be updated. For example, the vehicle may store real-time perception data indicative of a dangerous condition detected by the vehicle (or another vehicle) not represented in a corresponding danger value or danger map. In some examples, the vehicle may store the perception data on a local computer readable storage media (e.g., hard drive of the vehicle's onboard computer). In some examples, updating the perceived level of danger may include changing a danger value associated with a location of the danger map. Further, in some examples, the vehicle may determine a danger value based on the real-time perception data to store on the local storage media.

Alternatively or additionally, in some examples, the vehicle may update a danger map based on the updated danger value. In some examples, the vehicle accesses the danger map through a network interface or a wireless communication link with a server or a remote database, and the vehicle may communicate the danger value determined at block 230 to the server using the same means. In such examples, the danger map can be updated by the server or remote database based on the danger value communicated by the vehicle to the server. Alternatively or in addition, the vehicle may be configured to store the danger map on local computer readable storage media (e.g., hard drive of the vehicle's onboard computer). Further, the vehicle may store the danger value determined at block 230 on a local storage media. Updating the danger map may include changing a danger value associated with a location of the danger map. For example, updating a danger map may include increasing a danger value associated with a location in response to perception data that indicates a vehicle collision at that location. As another example, updating a danger map may include decreasing a danger value associated with a location in response to perception data that indicates previous road construction near the location has been completed. In some examples, a danger map may be automatically updated according to an expiration date of perception data and/or a danger value based on expired perception data.

At 250, in some examples, the vehicle may determine whether the current route and driving style are consistent with the real-time perception data of block 240. For example, the vehicle may use the real-time perception data to compare each danger value associated with one or more locations of the current route with a danger value threshold or a maximum danger value. In particular, the vehicle may reevaluate the current route by determining whether any danger value associated with a location of the current route exceeds a danger value threshold. In some examples, the danger value threshold can correspond to one or more thresholds for changing driving style (e.g., including speed, acceleration, following distance, and other characteristics described above) and/or one or more thresholds for avoiding an area with that danger value altogether. The danger value threshold can be determined based on user input or known user preferences, and can be based on the current driving style of the vehicle. For example, a user may indicate a first maximum danger value for a first driving style, and may indicate a second lower maximum danger value for a second driving style. In accordance with a determination that a danger value of a location falls outside of the minimum and maximum danger value range for a driving style, the driving style can be adjusted accordingly for that location. For example, in accordance with a low danger value (e.g., a danger value less than a danger value threshold), a less cautious driving style can be used including one or more of a higher speed, shorter following distance, faster acceleration, and/or other characteristics. In accordance with a high danger value (e.g., a danger value greater than the danger value threshold), a more cautious driving style can be used including, for example, one or more of a lower speed, longer following distance, slower acceleration, and/or other characteristics.

At block 260, in some examples, the vehicle may determine that the current route and driving style are consistent with the updated danger level, and in response, the vehicle may forgo modification of the route and the driving style. At block 270, in some examples, the vehicle may determine that the current route or driving style are inconsistent with the updated danger level, and in response, the vehicle may determine a new route or a new driving style. The vehicle may notify a user in response to determining that the current route or driving style is inconsistent with the real-time perception data. For example, the vehicle may alter a display, play one or more noises, or otherwise notify the user of the determined inconsistency. In some examples, a vehicle may transition from a first driving style into a second driving style, different from the first driving style, according to one or more examples described above.

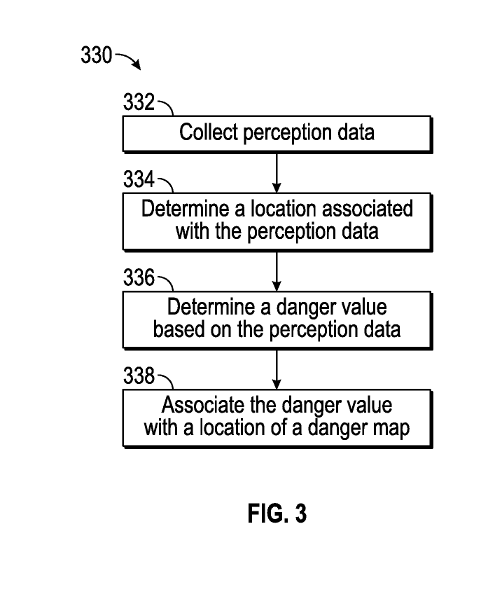

FIG. 3 illustrates an exemplary process 330 for collecting perception data and determining a danger value according to examples of the disclosure. In some examples, a danger value may be associated with a location and may be determined based on perception data. Process 330 can be performed continuously or repeatedly by the vehicle whenever information about a danger value of a location, or of the vehicle's current operation, is needed.

At block 332, in some examples, the process 330 may include collecting or receiving perception data indicative of various conditions of a vehicle's surroundings and determining a danger value based on the perception data. In some examples, a vehicle may determine whether perception data indicates a particular condition of the vehicle's surroundings by evaluating whether the perception data satisfies or exceeds several thresholds or criteria indicating a dangerous condition, as previously described. The vehicle may collect perception data using various vehicle sensors (e.g., radar, ultrasonic, LiDAR, various cameras, etc.) to detect a position, a velocity, or an acceleration of a vehicle, objects or debris near a road, or the vehicle's surroundings generally. In some examples, the perception data may also indicate an absence of a dangerous condition or may indicate that the vehicle has failed to detect a dangerous condition associated with its surroundings. The various thresholds and criteria of a dangerous condition may be determined by a user or by the vehicle (e.g., a default setting).

For example, the perception data may indicate a motorcycle is located within a threshold distance of the vehicle. The motorcycle may have a position, velocity, or acceleration exceeding a respective threshold for a motorcycle, indicating that the motorcycle is likely to perform a dangerous maneuver. The perception data may indicate a motorcycle as a dangerous condition, regardless of its position, velocity, or acceleration.

In some examples, the perception data may indicate a collision of a vehicle with another object. For example, the perception data may include a captured image of two vehicles that have crashed together. In some examples, the vehicle may register or detect a collision when it detects at least two non-moving vehicles on a shoulder of a freeway. The vehicle may also receive data from one or more traffic information providers to detect a collision. For example, the vehicle may receive a notification from a server in communication with the vehicle indicating an accident or a collision of two vehicles at a specified location. The vehicle may then register or detect the accident at the location specified.

In some examples, the perception data may indicate a near-miss of two or more vehicles. The perception data may indicate a near-miss of a vehicle and an object (e.g., another vehicle) based on a determined threshold of distance between a vehicle and another object and a determined threshold for the velocity of a vehicle relative to an object. For example, the vehicle may detect when a vehicle comes within a specified distance of another vehicle and with sufficient velocity relative to the other vehicle, such that a collision is avoided by performing an emergency avoidance maneuver or by swerving. As another example, the vehicle may detect when a vehicle moves into the lane of another vehicle forcing it to serve or move suddenly to avoid a collision.

In some examples, the perception data may indicate a blind turn or a location with limited visibility. The vehicle may detect a blind corner, blind spot, or a blind turn whenever it cannot sense objects beyond a predetermined threshold distance. In some examples, the vehicle may also evaluate whether it cannot sense objects beyond the threshold distance in the vehicle's current or expected direction of travel, or in some other direction. The vehicle may ignore a failure to sense objects beyond a threshold distance if the distance is directed orthogonally to the vehicle's direction of travel (e.g., driving next to a wall). Further, in some examples, the perception data may indicate an acceleration of another vehicle exceeds a determined acceleration threshold. The vehicle may detect a sufficiently large change in the velocity of another vehicle. That is, it may detect a sufficiently sudden stop or a rapid increase in velocity of another vehicle. In such examples, the vehicle can determine that the other vehicle is driving dangerously.

In some examples, at block 334, the vehicle can determine a location associated with the collected perception data. A vehicle can determine its location based on GPS or other positional sensors or by matching one or more perceived features (e.g., via a camera, Lidar, ultrasonic sensor, or other sensor) to one or more features included in an HD map. When the vehicle collects perception data, it can simultaneously determine its location and associate the location with the perception data. In some examples, the location can be a point at which the vehicle is located at the time it collects perception data. In some examples, the location can be an estimated location and area of the perceived danger. In some examples, the location can be an area including one or more of the vehicle's location, the location of the perceived danger, and/or extra area to account for measurement error.

At block 336, in some examples, a danger value can be determined based on the perception data of block 332. In some examples, block 336 can be performed by the vehicle, a smart traffic signal, a remote server, or another device. A danger value may be determined based on a quantity and/or degree of dangerous incidents or circumstances indicated by past and current perception data from one or more vehicles. For example, a high danger value can be associated with a location based on past and current perception data that indicates three dangerous incidents have occurred at the location during the past 24 hours. As another example, a low danger value can be associated with a location based on past and current perception data that indicates only 10 dangerous incidents or circumstances have been observed at a location during the past six months.

Alternatively or in addition, a danger value associated with a location may be determined based on the kinds of dangerous incidents or circumstances indicated by past and current perception data. For example, a higher danger value may be determined where past and current perception data indicate a vehicle collision than where past and current perception data indicate a parking lot. In some examples, dangerous incidents and circumstances may be categorized according to how dangerous an incident or circumstance is believed to be. For example, vehicle collisions, construction, near-misses, and extreme velocity may be categorized as high-danger incidents or high-danger circumstances. As another example, light traffic, parking lots, and motorcycles may be categorized as low-danger incidents or low-danger circumstances. Thus, a danger value may be determined to be larger or smaller based on a quantity and/or a kind of dangerous incident or circumstance indicated by past and current perception data.

The vehicle, or a system in communication with the vehicle such as a smart traffic device, a remote server, or other device, can aggregate all perception data associated with a location within an HD map. The aggregate perception data may include all previously collected perception data that is associated with a location of an HD map. Thus, the aggregate perception data may be a collection of perception data collected at various points in time, and that is all associated with the same location. For example, aggregate perception data may include perception data collected over several months and associated with a specific location of a freeway.

At block 338, in some examples, the danger value can be associated with a location of a danger map. Associating the danger value with a location on the danger map can include updating the danger map to reflect this new danger value. In some examples, a vehicle can update its own danger map based on perception data it gathers. In some examples, a server can update a danger map based on perception data received from several vehicles, and transmit the updated map to the several vehicles.

The location associated with perception data and the location of a danger value might not always be the same. For example, a danger value might be a larger location than the exact spot where an accident occurs. Alternatively, an entire stretch of road might be under construction, but the danger value based on the construction might be assigned to the exact location where construction is focused at a specific time.

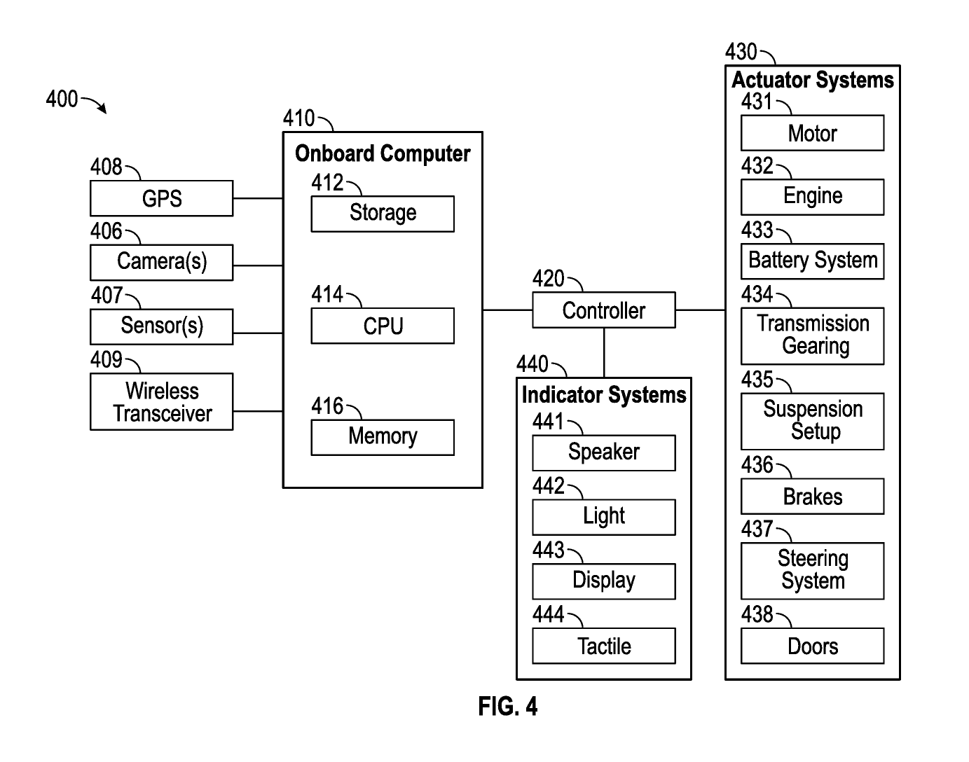

FIG. 4 illustrates an exemplary system block diagram of a vehicle control system 400 according to examples of the disclosure. Vehicle control system 400 can perform any of the methods described with reference to FIGS. 1, 2A-2B, and 3. Vehicle control system 400 can also include a wireless transceiver 409 capable of enabling wireless communication between the vehicle and a server or central processor, one or more other sensors 407 (e.g., radar, ultrasonic, LiDAR, etc.) and cameras 406 capable of detecting various characteristics of the vehicle's surroundings, and a Global Positioning System (GPS) receiver 408 capable of determining the location of the vehicle. Vehicle control system 400 can include an on-board computer 410 that is coupled to the cameras 406, sensors 407, GPS receiver 408, and wireless transceiver 409, and that is capable of receiving the image data from the cameras and/or outputs from the sensors 407, the GPS receiver 408, and the wireless transceiver 409. The on-board computer 410 can be capable of retrieving a danger map, collecting perception data, determining and communicating a danger value, and updating a danger map, as described in this disclosure. On-board computer 410 can include storage 412, memory 416, and a processor 414. Processor 414 can perform any of the methods described with reference to FIGS. 1, 2A-2B, and 3. Additionally, storage 412 and/or memory 416 can store data and instructions for performing any of the methods described with reference to FIGS. 1, 2A-2B, and 3. Storage 412 and/or memory 416 can be any non-transitory computer readable storage medium, such as a solid-state drive or a hard disk drive, among other possibilities. The vehicle control system 400 can also include a controller 420 capable of controlling one or more aspects of vehicle operation, such as modifying the vehicle's route or driving style in response to a danger value as determined by the on-board computer 410.

In some examples, the vehicle control system 400 can be connected to (e.g., via controller 420) one or more actuator systems 430 in the vehicle and one or more indicator systems 440 in the vehicle. The one or more actuator systems 430 can include, but are not limited to, a motor 431 or engine 432, battery system 433, transmission gearing 434, suspension setup 435, brakes 436, steering system 437 and door system 438. The vehicle control system 400 can control, via controller 420, one or more of these actuator systems 430 during vehicle operation; for example, to open or close one or more of the doors of the vehicle using the door actuator system 438, to control the vehicle's route or driving style, that can utilize the danger values and danger map determined by the on-board computer 410, using the motor 431 or engine 432, battery system 433, transmission gearing 434, suspension setup 435, brakes 436 and/or steering system 437, etc. The one or more indicator systems 440 can include, but are not limited to, one or more speakers 441 in the vehicle (e.g., as part of an entertainment system in the vehicle), one or more lights 442 in the vehicle, one or more displays 443 in the vehicle (e.g., as part of a control or entertainment system in the vehicle) and one or more tactile actuators 444 in the vehicle (e.g., as part of a steering wheel or seat in the vehicle). The vehicle control system 400 can control, via controller 420, one or more of these indicator systems 440 to provide indications to a driver of the vehicle of one or more danger values of a danger map that are determined using the on-board computer 410.

Therefore, according to the above, some examples of the disclosure are related to a method of operating a vehicle comprising receiving a danger map comprising a plurality of danger values, each danger value associated with a respective location on the map and determined based on perception data associated with the respective location and determining a route for the vehicle from a first location to a second location based on a plurality of danger values of a plurality of intermediate locations along the route indicated in the danger map. Additionally or alternatively to one or more of the examples disclosed above, the method further comprises while driving along the route: determining a danger value associated with a current vehicle location based on the danger value associated with the current vehicle location; comparing the determined danger value with a first danger value threshold; according to a determination that the danger value exceeds the first danger value threshold: modifying operation of the vehicle based on the determined danger value; and according to a determination that the danger value does not exceed the first danger value threshold: forgoing modification of vehicle operation based on the determined danger value. Additionally or alternatively to one or more of the examples disclosed above, modifying operation of the vehicle includes selecting a new route of the vehicle. Additionally or alternatively to one or more of the examples disclosed above, modifying operation of the vehicle includes transitioning from a first driving mode to a second driving mode, different from the first driving mode. Additionally or alternatively to one or more of the examples disclosed above, the first driving mode includes one or more of a first top speed, a first follow distance, a first lead distance, and a first plurality of criteria for changing lanes, and the second driving mode includes one or more of a second top speed, a second follow distance, a second lead distance, and a second plurality of criteria for changing lanes. Additionally or alternatively to one or more of the examples disclosed above, one or more of: the second top speed is lower than the first top speed, the second follow distance is longer than the first follow distance, the second lead distance is longer than the first lead distance, and the second plurality of criteria for changing lanes are different from the first plurality of criteria for changing lanes. Additionally or alternatively to one or more of the examples disclosed above, the perception data is collected by at least one vehicle. Additionally or alternatively to one or more of the examples disclosed above, the perception data is indicative of one or more of a vehicle traveling at a dangerous velocity, a vehicle performing an emergency breaking maneuver, a vehicle performing an emergency avoidance maneuver, a near miss of at least one vehicle and another object, or a collision event involving at least one vehicle. Additionally or alternatively to one or more of the examples disclosed above, the vehicle further comprises one or more sensors including one or more of a camera, a Lidar sensor, an ultrasonic sensor, and a radar sensor and receiving perception data includes collecting perception data with the one or more sensors. Additionally or alternatively to one or more of the examples disclosed above, receiving the danger map includes receiving the danger map from a server via a wireless network connection. Additionally or alternatively to one or more of the examples disclosed above, the method further comprises while driving along the route: moving from a first intermediate location of the route with a first danger value to a second intermediate location of the route with a second danger value, and modifying vehicle operation based on the second danger value. Additionally or alternatively to one or more of the examples disclosed above, the method further comprises, while driving along the route: moving from a first intermediate location of the route with a first danger value to a second intermediate location of the route with a second danger value, and changing from an autonomous mode to a manual mode based on the second danger value. Additionally or alternatively to one or more of the examples disclosed above, determining the route from the first location to the second location comprises: in accordance with a determination that the danger map has a first danger layout, selecting a first possible route as the route; and in accordance with a determination that the danger map has a second danger layout, selecting a second possible route as the route. Additionally or alternatively to one or more of the examples disclosed above, determining the route from the first location to the second location comprises: determining a first possible route having a first length and a first aggregate danger value; determining a second possible route having a second length longer than the first length and a second aggregate danger value less than the first aggregate danger value; and selecting the second route as the route. Additionally or alternatively to one or more of the examples disclosed above, the method further comprises, while driving along the route: detecting a change in a danger value on the danger map for a future intermediate location along the route; and in accordance with a determination that the change is an increase in the danger value, adjusting the route to avoid the future intermediate location.

According to the above, some examples of the disclosure are related to a vehicle comprising a processor, the processor configured for: receiving a danger map comprising a plurality of danger values, each danger value associated with a respective location on the map and determined based on perception data associated with the respective location; and determining a route for the vehicle from a first location to a second location based on a plurality of danger values of a plurality of intermediate locations along the route indicated in the danger map. Additionally or alternatively to one or more of the examples disclosed above, the processor is further configured for: determining a danger value associated with a current vehicle location based on the danger value associated with the current vehicle location; comparing the determined danger value with a first danger value threshold; according to a determination that the danger value exceeds the first danger value threshold: modifying operation of the vehicle based on the determined danger value; and according to a determination that the danger value does not exceed the first danger value threshold: forgoing modification of vehicle operation based on the determined danger value. Additionally or alternatively to one or more of the examples disclosed above, modifying operation of the vehicle includes selecting a new route of the vehicle. Additionally or alternatively to one or more of the examples disclosed above, modifying operation of the vehicle includes transitioning from a first driving mode to a second driving mode, different from the first driving mode. Additionally or alternatively to one or more of the examples disclosed above, the first driving mode includes one or more of a first top speed, a first follow distance, a first lead distance, and a first plurality of criteria for changing lanes, and the second driving mode includes one or more of a second top speed, a second follow distance, a second lead distance, and a second plurality of criteria for changing lanes. Additionally or alternatively to one or more of the examples disclosed above, one or more of: the second top speed is lower than the first top speed, the second follow distance is longer than the first follow distance, the second lead distance is longer than the first lead distance, and the second plurality of criteria for changing lanes are different from the first plurality of criteria for changing lanes. Additionally or alternatively to one or more of the examples disclosed above, the perception data is collected by at least one vehicle. Additionally or alternatively to one or more of the examples disclosed above, the perception data is indicative of one or more of a vehicle traveling at a dangerous velocity, a vehicle performing an emergency breaking maneuver, a vehicle performing an emergency avoidance maneuver, a near miss of at least one vehicle and another object, or a collision event involving at least one vehicle. Additionally or alternatively to one or more of the examples disclosed above, the vehicle further comprises one or more sensors including one or more of a camera, a Lidar sensor, an ultrasonic sensor, and a radar sensor and receiving perception data includes collecting perception data with the one or more sensors. Additionally or alternatively to one or more of the examples disclosed above, receiving the danger map includes receiving the danger map from a server via a wireless network connection. Additionally or alternatively to one or more of the examples disclosed above, the processor is further configured for, while driving along the route: moving from a first intermediate location of the route with a first danger value to a second intermediate location of the route with a second danger value, and modifying vehicle operation based on the second danger value. Additionally or alternatively to one or more of the examples disclosed above, the processor is further configured for, while driving along the route: moving from a first intermediate location of the route with a first danger value to a second intermediate location of the route with a second danger value, and changing from an autonomous mode to a manual mode based on the second danger value. Additionally or alternatively to one or more of the examples disclosed above, determining the route from the first location to the second location comprises: in accordance with a determination that the danger map has a first danger layout, selecting a first possible route as the route; and in accordance with a determination that the danger map has a second danger layout, selecting a second possible route as the route. Additionally or alternatively to one or more of the examples disclosed above, determining the route from the first location to the second location comprises: determining a first possible route having a first length and a first aggregate danger value; determining a second possible route having a second length longer than the first length and a second aggregate danger value less than the first aggregate danger value; and selecting the second route as the route. Additionally or alternatively to one or more of the examples disclosed above, the processor is further configured for, while driving along the route: detecting a change in a danger value on the danger map for a future intermediate location along the route; and in accordance with a determination that the change is an increase in the danger value, adjusting the route to avoid the future intermediate location.

Therefore, according to the above, some examples of the disclosure are related to a non-transitory computer-readable storage medium storing instructions that, when executed by one or more processors of a vehicle, causes the processor to perform a method of operating a vehicle, the method comprising comprising: receiving a danger map comprising a plurality of danger values, each danger value associated with a respective location on the map and determined based on perception data associated with the respective location; and determining a route for the vehicle from a first location to a second location based on a plurality of danger values of a plurality of intermediate locations along the route indicated in the danger map. Additionally or alternatively to one or more of the examples disclosed above, the method further comprises, while driving along the route: determining a danger value associated with a current vehicle location based on the danger value associated with the current vehicle location; comparing the determined danger value with a first danger value threshold; according to a determination that the danger value exceeds the first danger value threshold: modifying operation of the vehicle based on the determined danger value; and according to a determination that the danger value does not exceed the first danger value threshold: forgoing modification of vehicle operation based on the determined danger value. Additionally or alternatively to one or more of the examples disclosed above, modifying operation of the vehicle includes selecting a new route of the vehicle. Additionally or alternatively to one or more of the examples disclosed above, modifying operation of the vehicle includes transitioning from a first driving mode to a second driving mode, different from the first driving mode. Additionally or alternatively to one or more of the examples disclosed above, the first driving mode includes one or more of a first top speed, a first follow distance, a first lead distance, and a first plurality of criteria for changing lanes, and the second driving mode includes one or more of a second top speed, a second follow distance, a second lead distance, and a second plurality of criteria for changing lanes. Additionally or alternatively to one or more of the examples disclosed above, one or more of: the second top speed is lower than the first top speed, the second follow distance is longer than the first follow distance, the second lead distance is longer than the first lead distance, and the second plurality of criteria for changing lanes are different from the first plurality of criteria for changing lanes. Additionally or alternatively to one or more of the examples disclosed above, the perception data is collected by at least one vehicle. Additionally or alternatively to one or more of the examples disclosed above, the perception data is indicative of one or more of a vehicle traveling at a dangerous velocity, a vehicle performing an emergency breaking maneuver, a vehicle performing an emergency avoidance maneuver, a near miss of at least one vehicle and another object, or a collision event involving at least one vehicle. Additionally or alternatively to one or more of the examples disclosed above, the vehicle further comprises one or more sensors including one or more of a camera, a Lidar sensor, an ultrasonic sensor, and a radar sensor and receiving perception data includes collecting perception data with the one or more sensors. Additionally or alternatively to one or more of the examples disclosed above, receiving the danger map includes receiving the danger map from a server via a wireless network connection. Additionally or alternatively to one or more of the examples disclosed above, the method further comprises, while driving along the route: moving from a first intermediate location of the route with a first danger value to a second intermediate location of the route with a second danger value, and modifying vehicle operation based on the second danger value. Additionally or alternatively to one or more of the examples disclosed above, method further comprises, while driving along the route: moving from a first intermediate location of the route with a first danger value to a second intermediate location of the route with a second danger value, and changing from an autonomous mode to a manual mode based on the second danger value. Additionally or alternatively to one or more of the examples disclosed above, determining the route from the first location to the second location comprises: in accordance with a determination that the danger map has a first danger layout, selecting a first possible route as the route; and in accordance with a determination that the danger map has a second danger layout, selecting a second possible route as the route. Additionally or alternatively to one or more of the examples disclosed above, determining the route from the first location to the second location comprises: determining a first possible route having a first length and a first aggregate danger value; determining a second possible route having a second length longer than the first length and a second aggregate danger value less than the first aggregate danger value; and selecting the second route as the route. Additionally or alternatively to one or more of the examples disclosed above, the method further comprises, while driving along the route: detecting a change in a danger value on the danger map for a future intermediate location along the route; and in accordance with a determination that the change is an increase in the danger value, adjusting the route to avoid the future intermediate location.

According to the above, some examples of the disclosure are related to a method of generating a danger map comprising: determining at least one location of interest; collecting perception data associated with the at least one location of interest, wherein the perception data is collected via one or more vehicles over a period of time; generating aggregate perception data associated with the at least one location of interest based on the perception data associated with the at least one location of interest and collected by the one or more vehicles over the period of time; and determining at least one danger value associated with the at least one location of interest based on the generated aggregate perception data, wherein the at least one danger value is used to generate the danger map.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. A method of operating a vehicle comprising:
receiving a danger map comprising a plurality of danger values, each danger value associated with a respective location on the map and determined based on perception data associated with the respective location; and
determining a route for the vehicle from a first location to a second location based on a plurality of danger values of a plurality of intermediate locations along the route indicated in the danger map.

2. The method of claim 1, further comprising, while driving along the route:
determining a danger value associated with a current vehicle location based on the danger value associated with the current vehicle location;
comparing the determined danger value with a first danger value threshold;
according to a determination that the danger value exceeds the first danger value threshold:
modifying operation of the vehicle based on the determined danger value; and
according to a determination that the danger value does not exceed the first danger value threshold:
forgoing modification of vehicle operation based on the determined danger value.

3. The method of claim 2, wherein modifying operation of the vehicle includes selecting a new route of the vehicle.

4. The method of claim 2, wherein:
modifying operation of the vehicle includes transitioning from a first driving mode to a second driving mode, different from the first driving mode, and
wherein the first driving mode includes one or more of a first top speed, a first follow distance, a first lead distance, and a first plurality of criteria for changing lanes, and the second driving mode includes one or more of a second top speed, a second follow distance, a second lead distance, and a second plurality of criteria for changing lanes.

5. The method of claim 4, wherein one or more of: the second top speed is lower than the first top speed, the second follow distance is longer than the first follow distance, the second lead distance is longer than the first lead distance, and the second plurality of criteria for changing lanes are different from the first plurality of criteria for changing lanes.

6. The method of claim 1, wherein the perception data is collected by at least one vehicle and the perception data is indicative of one or more of a vehicle traveling at a dangerous velocity, a vehicle performing an emergency breaking maneuver, a vehicle performing an emergency avoidance maneuver, a near miss of at least one vehicle and another object, or a collision event involving at least one vehicle.

7. The method of claim 1, further comprising, while driving along the route:
moving from a first intermediate location of the route with a first danger value to a second intermediate location of the route with a second danger value, and
modifying vehicle operation based on the second danger value.

8. The method of claim 1, further comprising, while driving along the route:
moving from a first intermediate location of the route with a first danger value to a second intermediate location of the route with a second danger value, and
changing from an autonomous mode to a manual mode based on the second danger value.

9. The method of claim 1, further comprising, while driving along the route:
detecting a change in a danger value on the danger map for a future intermediate location along the route; and
in accordance with a determination that the change is an increase in the danger value, adjusting the route to avoid the future intermediate location.

10. A vehicle comprising a processor, the processor configured for:
receiving a danger map comprising a plurality of danger values, each danger value associated with a respective location on the map and determined based on perception data associated with the respective location; and
determining a route for the vehicle from a first location to a second location based on a plurality of danger values of a plurality of intermediate locations along the route indicated in the danger map.

11. The vehicle of claim 10, the processor further configured for:
determining a danger value associated with a current vehicle location based on the danger value associated with the current vehicle location;
comparing the determined danger value with a first danger value threshold;
according to a determination that the danger value exceeds the first danger value threshold:
modifying operation of the vehicle based on the determined danger value; and
according to a determination that the danger value does not exceed the first danger value threshold:
forgoing modification of vehicle operation based on the determined danger value.

12. The vehicle of claim 11, wherein modifying operation of the vehicle includes selecting a new route of the vehicle.

13. The vehicle of claim 11, wherein:
modifying operation of the vehicle includes transitioning from a first driving mode to a second driving mode, different from the first driving mode.

14. The vehicle of 13, wherein the first driving mode includes one or more of a first top speed, a first follow distance, a first lead distance, and a first plurality of criteria for changing lanes, and the second driving mode includes one or more of a second top speed, a second follow distance, a second lead distance, and a second plurality of criteria for changing lanes.

15. The vehicle of claim 14, wherein one or more of: the second top speed is lower than the first top speed, the second follow distance is longer than the first follow distance, the second lead distance is longer than the first lead distance, and the second plurality of criteria for changing lanes are different from the first plurality of criteria for changing lanes.

16. The vehicle of claim 11, wherein the perception data is indicative of one or more of a vehicle traveling at a dangerous velocity, a vehicle performing an emergency breaking maneuver, a vehicle performing an emergency avoidance maneuver, a near miss of at least one vehicle and another object, or a collision event involving at least one vehicle.

17. The vehicle of claim 11, wherein the processor is further configured for, while driving along the route:
moving from a first intermediate location of the route with a first danger value to a second intermediate location of the route with a second danger value, and
modifying vehicle operation based on the second danger value.

18. The vehicle of claim 11, wherein the processor is further configured for, while driving along the route:
moving from a first intermediate location of the route with a first danger value to a second intermediate location of the route with a second danger value, and
changing from an autonomous mode to a manual mode based on the second danger value.

19. The vehicle of claim 11, wherein determining the route from the first location to the second location comprises:
in accordance with a determination that the danger map has a first danger layout, selecting a first possible route as the route; and
in accordance with a determination that the danger map has a second danger layout, selecting a second possible route as the route.

20. A method of generating a danger map comprising:
determining at least one location of interest;
collecting perception data associated with the at least one location of interest, wherein the perception data is collected via one or more vehicles over a period of time;
generating aggregate perception data associated with the at least one location of interest based on the perception data associated with the at least one location of interest and collected by the one or more vehicles over the period of time; and
determining at least one danger value associated with the at least one location of interest based on the generated aggregate perception data, wherein the at least one danger value is used to generate the danger map.
